(19) United States
(12) Patent Application Publication
(10) Pub. No.: US 2005/0289502 A1
(43) Pub. Date: Dec. 29, 2005

(54) Infrastructure-aware application development

(76) Inventors: Parul A. Mittal, Gurgaon (IN); Ashish Kundu, Mayurbhanj Orissa (IN); Amit Anil Nanavati, New Delhi (IN)

Correspondence Address: Frederick W. Gibb, III;McGinn & Gibb, PLLC, Suite 304, 2568-A Riva Road, Annapolis, MD, 21401, US

(21) Appl. No.: 10/880,124

(22) Filed: Jun. 29, 2004

(51) Int. Cl. G06F 9/44

(52) U.S. Cl. 717/100

(57) ABSTRACT

Constraints associated with hardware upon which the application is to be deployed are determined, and parameters associated with the determined constraints are recorded for later use. Parameters may be static or dynamic in nature. Conflicts between determined constraints having incompatible parameters are resolved using a “consistent union” approach.

### FIELD OF THE INVENTION

The present invention relates to the development of applications that are capable of executing normally under various infrastructural conditions.

### BACKGROUND

Applications are developed keeping in mind the infrastructure on which the application is to execute. This “execution infrastructure” includes the execution environment, such as the relevant hardware, the operating system, the network architecture and properties, availability of dependant services, client connectivity, etc.

As an example, a web application is developed knowing that the client is available throughout the period between sending a request and receiving a response back from the application during runtime. The client-side network is presumed to allow the response to be delivered to the client, irrespective of the size of the response. Given these two assumptions, the application development does not allow the client to retrieve its response, if the client will not be available for some time. This is because the application is developed only for clients that have the infrastructural capability to remain available, and to accept responses of any size.

However, if client-side infrastructure does not allow a client to accept a message of size greater than “D”, then the application is rewritten to split a large response (whose size is more than “D”) into several smaller ones, and then to send these multiple responses back to the client at proper intervals. The interval duration is also dictated by the client infrastructure.

A symmetric example can be constructed for server-side infrastructure as well. Suppose that a service “S1” used by the application is not available for each alternate hour due to infrastructure limitations. In another infrastructure environment, the same service may become unavailable in an arbitrary fashion. However, the application has to receive and record incoming data and requests, and if possible process such data and requests in all infrastructures. The “brute force” technique is simply to rewrite the application for each infrastructure. In fact if there are five infrastructural factors at the server-side and four at the client-side, in the worst case, the application is rewritten in twenty versions! Thus a need exists for an automatically enabling the application to handle all such infrastructural “constraints” either in a single version, or in multiple versions which are automatically generated with minimum manual intervention.

Existing Rapid Application Development (RAD) tools enable users to build applications and application templates, using visual editors, without having to program actual code. These RAD tools handle application-specific configurations, such as web page design, data source configuration, and business logic variations. Many applications, however, are increasingly required to be deployed on client devices having different capabilities. An example is an application that may be used by a personal computer (PC), as well as by a personal digital assistant (PDA).

A need clearly exists, in view of these and other observations, for a manner of developing applications that takes into account varying infrastructural capabilities.

### SUMMARY

Infrastructural constraints are handled at design and development time, and development based upon established infrastructural constraints (client-side, server-side and resource-side) can be handled. A development tool capable of making normal applications more robust and flexible integrates such infrastructural constraints.

Constraints associated with infrastructural hardware/software upon which the application is to be deployed are determined, and parameters associated with the determined constraints are recorded for later use. Parameters may be static or dynamic in nature. Conflicts between determined constraints having incompatible parameters are resolved using a “consistent union” approach.

Application components are generated, and in some cases developers may be prompted to use a suitable Application Programming Interface (API) based upon the recorded parameters of the determined constraints.

### DESCRIPTION OF DRAWINGS

FIG. 1 is a schematic representation of a system architecture in which applications are developed.

FIG. 2 is a schematically representation of a system architecture used for handling infrastructural constraints.

FIG. 3 is a flowchart of steps involved in handling constraints.

FIG. 4 is a flowchart of steps involved in processing constraints having varied availability parameters.

FIG. 5 is a flowchart of steps used by an adaptive component generated for handling resource availability constraints. These steps show the application behaviour at runtime.

FIG. 6 is a schematic representation of a computer system suitable for performing the techniques described herein.

### DETAILED DESCRIPTION

An infrastructural constraint can be defined as a parameter that requires an application to behave differently when the application is executed on infrastructures for which the parameter assumes different values. For example, network availability is a constraint; a network-based application can operate differently in an “always-available” network than in an “intermittently available” network.

Server-side, client-side and resource constraints are described below before further describing specific aspects of how applications are developed taking account of such constraints.

Application components can be developed for deployment time static configuration as well as for runtime dynamic configurations. Application behaviour may be automatically adapted based upon deployment parameters and runtime parameters.

There are two kinds of constraints possible—static and dynamic. The static constraints are those whose values could be determined before the execution of the application (for example, the network at server side would be available every alternate hour at some place and at another place, it is available all the time, but the maximum response size is limited to 5 KB).

Dynamic constraints are the ones, whose values are not known statically (that is deployment or development time). Some or all values of such constraints are identified during the runtime. Either some monitoring techniques or prediction techniques or both together can be used to determine the values of the dynamic constraints during runtime. Static constraints are used to generate a static configuration, which is fixed no later than the deployment stage of the application. Dynamic constraints are handled by changing the configuration of the application dynamically and/or by using components that are “intelligent” enough to change their behaviour based on the latest constraint values.

Server-Side Constraints

Servers upon which an application is deployed may vary in processor speed, memory size, network speed, etc. Consider an application that is built using several components. All components may reside on a large server and be deployed in a “tightly-coupled” manner, and may communicate using shared memory.

With several smaller servers, one might choose to deploy the various components on separate machines (“loosely-coupled”) and the components may communicate using messaging rather than shared memory. A user can select the nature of coupling at design-time to support code for either environment, or at deployment time to select the coupling for the particular deployment. Therefore the “deployment constraint’ if known at application development time then the application can be automatically adapted for each of the possible deployment constraint. For example, values of such a constraint may be an option do deploy the application on a single server, on a closely coupled cluster using MPI. or on a distributed server—remotely located using HTTP to communicate.

Similarly, the use of alternative data structures (for example, a Java™ language hash map versus a fast database) and caching (on or off) depends on the memory and processor speed of the relevant servers. Code for alternative schemes is available and can be accessed as needed.

Client-Side Constraints

Applications that are aware of and can handle constraints imposed by clients that access the applications are contemplated. The clients can be stationery or mobile, such as desktop computers or laptops respectively. So this is a mobility constraint. The network availability or response mechanism (synchronous or asynchronous) may be another constraint, which would require the application be adapted for all such capabilities.

Table 1 below outlines some constraints, grouped by type.

TABLE 1
Client-to-server communications

| (a) | Proxy constraints: network bandwidth, ftp/telnet capability, etc. on |
|---|---|
| | (i) client-to-server connection |
| | (ii) server-to-client connection |

Network parameters and constraints

| (a) | security |
|---|---|
| (b) | communication |
| | (i) synchronous and asynchronous protocols |
| | (ii) wired or wireless |
| (c) | network bandwidth |
| (d) | network capability: voice/multimedia supported; Voice over IP, |
| | Voice over mobile IP |
| (e) | network connectivity and resiliency |
| | (i) network always available |
| | (ii) availability non-deterministic |
| (f) | maximum data transfer block supported |

Client availability

| (a) | client is shutdown |
|---|---|
| | (i) never |
| | (ii) over a deterministic period |
| | (iii) over a non-deterministic period |
| (b) | client is partially functional as other dependant services shutdown |
| | (like decryption). |

Client infrastructure differs from server infrastructure. The edge of the network might or might not contain a firewall. Whenever there is a firewall, such a demarcation over infrastructural capabilities change. A client can be connected to a server through proxy/firewall.

Resource Constraints

Applications can be developed that are aware of and can handle constraints imposed by the resources that the application uses or will use in the future. Examples of resources that an application uses are different types of data sources, the external or internal services, the legacy applications and a plurality of external systems. Consider the various infrastructural constraints imposed by different resources mentioned above, and how the developer can incorporate them in the application being developed.

The resources may be available only during a specified time, such as 2 pm to 5 pm weekdays, or only on Saturdays, or during the “non-peak” traffic times. This requires the application to be aware of various availability parameters and access the resources accordingly.

Development Tool

The development tool T described herein provides mechanisms to handle static and dynamic configurations. For static constraints, different versions of the application are generated, which require no need of later configurations (hard-coding the values of the constraints in the adapted versions).

A second technique generates different configurations, which need to be used while deploying the application. A third technique is to generate adaptive components which automatically detect the current value of the constraint (such as from a set of fixed values) and change the behaviour of the application (such as reduce the data transfer rate to the other component). A hybrid technique might use all three of the techniques in combination.

Changing a configuration dynamically means that one component might change the configuration and other components read the modified configuration and update their behaviour accordingly. Another way to dynamically change the behaviour of the application dynamically is to incorporate intelligent (adaptive) components the application it so that the components directly interact with the other components to control the behaviour of the application.

For dynamic constraints, the technique is to either dynamically change the configuration or to generate adaptive components, or doing both. The original components of the application can be made adaptive and/or new adaptive components are can be added to the application during adaptation. Instantiation of the adaptive components might be based on the runtime values (such as increasing the number of threads). Handling of a constraint means changing the behaviour of the application. The runtime behaviour of the application can be changed by either changing the component/logic that is relevant to the client, or by changing the server-side component/logic, or by configuration parameter values or by generating or modifying already generated adaptive components. Table 3 below lists out all these alternatives.

Consider an application that is deployed on a single server, or on a cluster of servers and on a remotely distributed set of servers. The application is deployed on infrastructures, in one of which the network is always available, in another a different protocol is used and the network is available only for the first half of the day, and in another the network goes down arbitrarily. An infrastructure-aware development tool uses a programming methodology to identify which are the constraints and how to handle them by either using some associated libraries or without any libraries.

As an example, any components responsible for communication need to be properly adapted for all three kinds of communication protocols. Libraries for each of these protocols can be used in the application. A lean version can be prepared beforehand if the executable becomes too large for a machine. That is, one can have the same application compiled separately for large servers as well as small servers. The developer can be presented with a set of infrastructural features from which the developer can select. Based on the selections, the tool T adds appropriate libraries to the code.

A further example involves a common set of APIs, which are implemented underneath as shared memory rather than messaging, and actual fetching rather than caching. At deployment time, based on the configuration of the environment (hardware and software), the appropriate modules can be installed and enabled for the runtime. Smaller executables can be deployed on smaller machines by enabling appropriate compiler/linker options, and some components may be deployed remotely.

The infrastructural parameters of the client-side are a “consistent union” of the proxy-based parameters, network parameters, client-specific parameters etc as listed above. The union is consistent so that there are no contradicting parameter values. For example, the total network bandwidth cannot be more than the bandwidth supported by the proxy. From the developer's perspective the tool allows the developer to specify if the application needs to access resources with varied availability parameters.

Consistent Union of Infrastructural Constraints

The tool T implements a consistent union technique. A developer develops a server-side application using T. The infrastructure constraints that the developer uses for the development are: client-side constraints and server-side constraints. In client-side constraints, network bandwidth from client to the proxy is specified as 256 KBps, and the network bandwidth of the proxy to which the client connects is specified as 64 KBps.

These parameters are semantically related and thus T should treat them together rather than separately. T should use the minimum value of the parameters as the possible network bandwidth available for connection between client and application. For this purpose. T does not take a normal union of all the parameter values supplied by the developed. Instead, T resolves conflicts between the network bandwidth values and uses a common value for that group of parameters.

Using the above method to adapt an application to infrastructural constraints, an embodiment of the development methodology using wizards is described below.

Tool T incorporates “wizards” and other components that are dynamically loadable and unloadable as required. When application development is initiated, the developer tool T can use an infrastructure with the appropriate constraints. The wizard receives the constraints as input. Based on the input, the tool loads the wizards and the dependency between the wizards (for example, network of client-side and network of server-side: the application has to adapt to the minimum of these bandwidths).

The tool T has wizards for each of the broad category of constraints (for example, the categories outlined in Table 1 above). The wizards may in cases be independent of each other, though dependant on each other in some cases. For example, the wizards for client-side constraint handling and server-side constraint handling for networks would be inter-dependant on each other. This is because, the generated application for a given value of (client-side-value, server-side-value) should be very equivalent, otherwise the application would not be able to communicate with the client well. The wizards generate application components for deployment time static configuration, for runtime dynamic configurations, and for automatic adaptation of application behaviour based on deployment or runtime parameters. The wizards also generate configurations for static constraints of needed.

Table 2 below outlines steps that are performed by a development tool T.

TABLE 2

| | |
|---|---|
| Step 1 | Make other components ready to receive constraints for |
| | category Cᵢ. |
| Step 2 | Receive the infrastructural constraints for category Cᵢ |
| | as entered by the developer. |
| Step 3 | Find the constraints that can be used to generate a set of static |
| | configuration. |
| Step 4 | Generate static configuration or automatic components for |
| | these parameters. |
| Step 5 | Find constraints that are dynamic in nature (though |
| | known at runtime). |
| Step 6 | Generate configuration and components for these parameters, |
| | if possible. |
| Step 7 | Integrate these generated configurations and components |
| | with the application. |
| Step 8 | Find constraints that are related to other category of constraints. |
| Step 9 | Repeat steps 1 to 7 for a new category Cⱼ. |
| Step 10 | Generate and integrate configuration and automatic |
| | components for remaining parameters |
| Step 11 | Generate versions of the whole application for different |
| | constraint values. |

Handling of Constraints

The tool T handles the constraints specified by some or all the means outlines in Table 3 below.

TABLE 3

| | |
|---|---|
| 1. | Modify client-side component/logic of the application |
| 2. | Modify server-side component/logic of the application |
| 3. | Generate/modify application configuration parameters |
| 4. | Generate/modify runtime-adaptive components |

The tool T might modify the client-side component of the application so that this component behaves consistently with the modified server-side counterpart of the same application. The tool can modify the server-side logic as well to handle the constraints. If the parameter values are already known, then the above techniques are used by the tool T. The tool T can generate a single version of the application that can handle all the possible values as specified by the developer.

The tool T can on the other hand generate multiple versions of the application for a set of values of the parameters. If the parameter values are known at deployment time, then the tool generates a deployment configuration or modifies the existing one. The tool T also can take an alternate solution for this—an adaptive component can be generated for the application, and this adaptive component can handle these various values. If the parameter values are runtime-dependant, then the tool generates runtime adaptive components that determine the parameter values at runtime at a given point of time, and accordingly change the behaviour of the application.

Tool T is used to develop application A. The developer uses two kinds of network connectivity between client and the server as constraints. First, client-to-server has bandwidth two values: 28.8 Kbps and 256 Kbps. Second, client-to-server bandwidth can be runtime-dependant.

The tool T accepts these values. The application generates some multimedia data to be sent to the client. The tool T generates three versions of the application. Version 1 (A₁) has the logic modified such that the application would generate the multimedia data such that the fits to the 28.8 Kbps. Version 2 (A₂) is identical to A₁, but has capability for 256 Kbps. Version 3 (A₃) has an adaptive-component generated by the tool such that the component acts as a filter of the multimedia output generated by the application.

The developer now adds a new constraint that a client is available only for a maximum time slice of 15 minutes. The client network bandwidth is 2 Mbps. The tool thus generates another version of application. Version 4 (A₄) has a new component at the server side that is responsible for storing the responses to client requests if these cannot be delivered to the client. Next time, when the client is activated and requests responses, this component sends the responses back to the client.

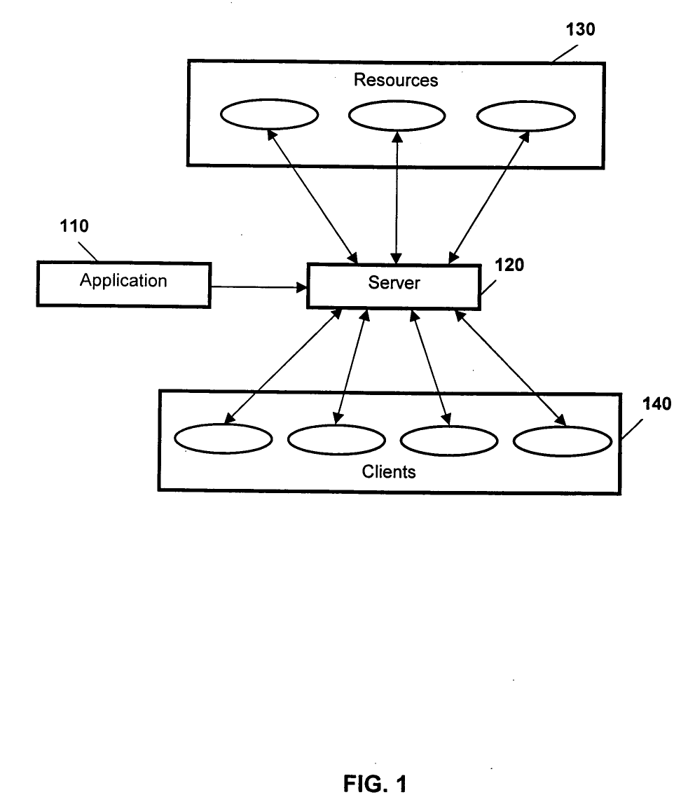

FIG. 1 schematically represents a generic system architecture in which applications 110 may be developed. An application 110 executes on a server 120, drawing upon resources 130, and serving clients 140. Applications 110 are subject to infrastructural constraints. These constraints can be due to the server 120, the resources 130 that the application uses, or the clients 140.

As an example, relevant infrastructure at the server 120 may include the server configuration, number of servers, capabilities of the server, the proxy, fault-tolerance requirements and network connectivity. The resources 130 that the application uses may have varied network connectivity, availability, and bandwidth. The relevant infrastructure of the client 140 may include the client-side proxy, firewall, network, and load pattern. Further, these constraints may be relevant at different stages of an application life-cycle. Such different stages may be design time, deployment time and run-time.

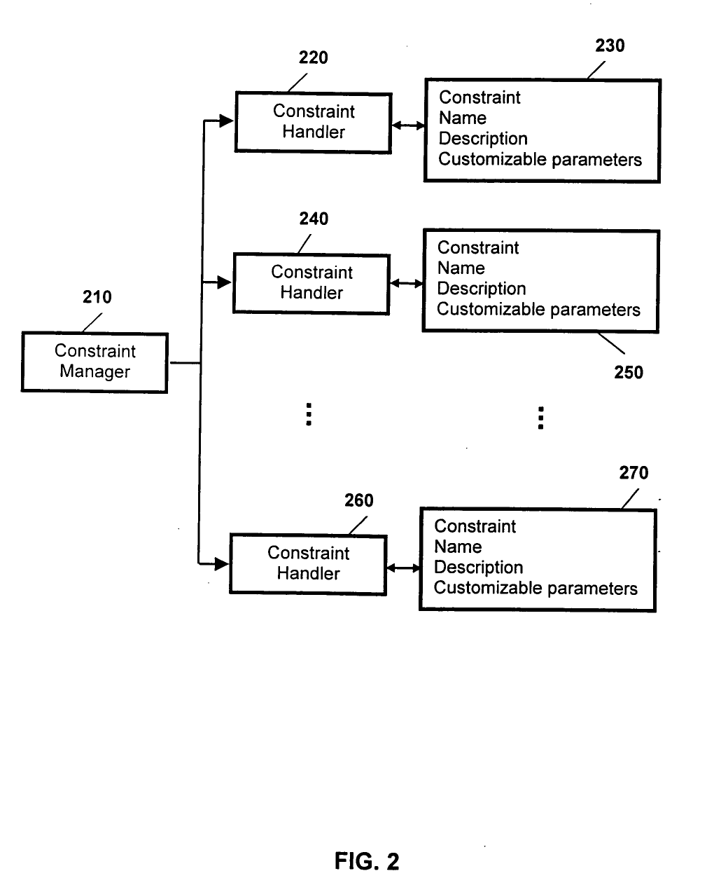

FIG. 2 schematically represents a system architecture used for handling infrastructral constraints. A Constraint Manager 210 and a plurality of Constraint Handlers 220 handle different types of infrastructural Constraints 230. Each Constraint Handler 220 stores a Constraint 230 that the Constraint Handler 220 handles. Each Constraint 230 includes a description of the constraint, a name, and a set of variable parameters. The Constraint Manager 210 guides the developer to incorporate various types of constraints during application development.

For each Constraint 230 that a developer chooses to incorporate in the application, the Constraint Manager 210 invokes the respective Constraint Handler 220. The Constraint Manager 220 specifies the variable parameters handled by the Constraint Handler 220.

The Constraint Handler 220 can either prompt the developer to use a specific application programming interface (API) or library, or automatically incorporate the Constraint 230 in the application, depending on the specific Constraint Handler 220. Automatic incorporation may involve storing variable parameter values in a configuration file, or generating application components.

Procedural Overview

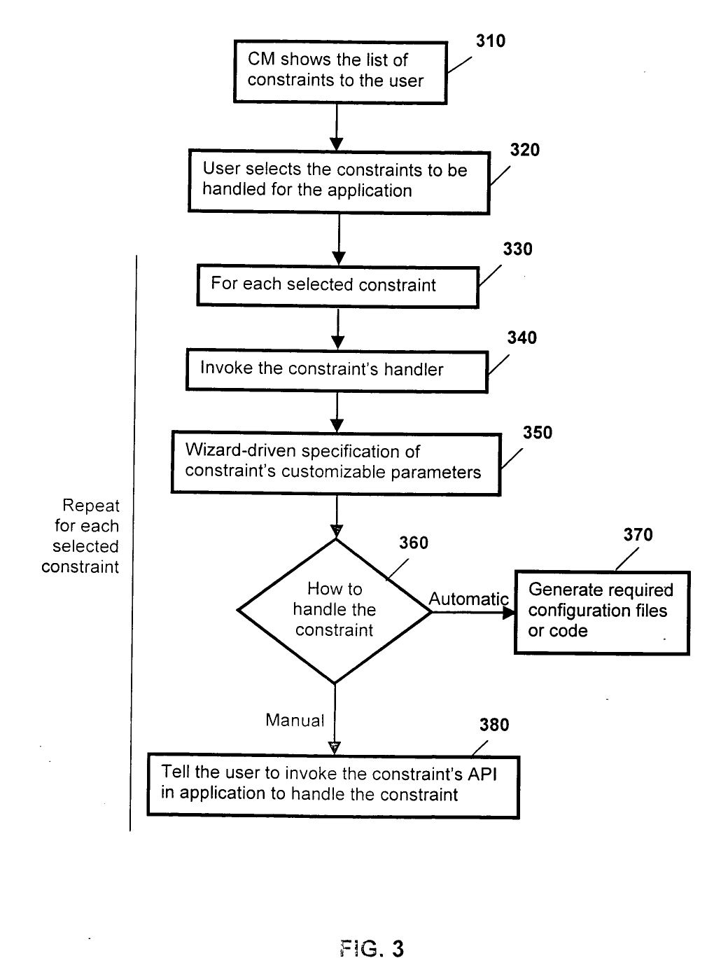

FIG. 3 is a flow chart of steps involved in handling each constraint 230. First, the Constraint Manager shows a list of possible constraints to the developer in step 310. The developer selects the Constraints 230 that are to be accommodated for a particular application. A determination is made in step 330 as to whether there are constraints to be accommodated. For each successive constraint, steps 340 to 380 are performed, as herein described.

The Constraint Handler 220 of a selected Constraint 230 is invoked in step 340. Variable parameters of the Constraint 230 are specified in step 350. A determination is made in step 360 as to how the Constraint 230, now fully specified, is to be handled. If the Constraint is automatically handled, the required configuration files or code are generated in step 370. Otherwise, if the Constraint 230 is to be manually handled, the developer is prompted in step 380 to invoke in the application a suitable Application Programming Interface (API) to handle the Constraint 230. Each Constraint 230 is handled in turn in this manner.

A Constraint Handler 220 can handle a plurality of Constraints 230. Constraints 230 that a user selects in step 320 may be conflicting, and require a resolution before proceeding further. The Constraint Manager 210 in this case checks for conflicting constraints, each time variable parameters of the Constraint Handler 220 are specified. A developer can if necessary be asked to choose between conflicting constraints, to arrive at a final set of non-conflicting constraints. The order of specifying Constraints 230 may be used to determine their priority at first instance. A check is made for conflicts every time a new parameter is specified.

The Constraint Manager 210 may take the variable parameter values for all Constraints 230 and then take a consistent union of the parameters. Consistent union eliminates duplicates and highlights conflicting values. The user is then prompted to select between the conflicting values, until the final set of non-conflicting constraints can be derived.

The Constraint Handlers 220 may also be inter-dependent, requiring invocation of the Constraint Handlers 220 in a specific sequence. In this case, the Constraint Handlers 220 are invoked in the specified sequence to take user inputs on the variable parameters.

The tool T then follows the method described in flowchart 1. The tool follows this method at a stretch or intermittently during the application development. At the end of application development the tool generates the deployable (for example, a .war file) file for the whole application.

Some sample Constraint Handlers 220 and their configuration steps are described as follows.

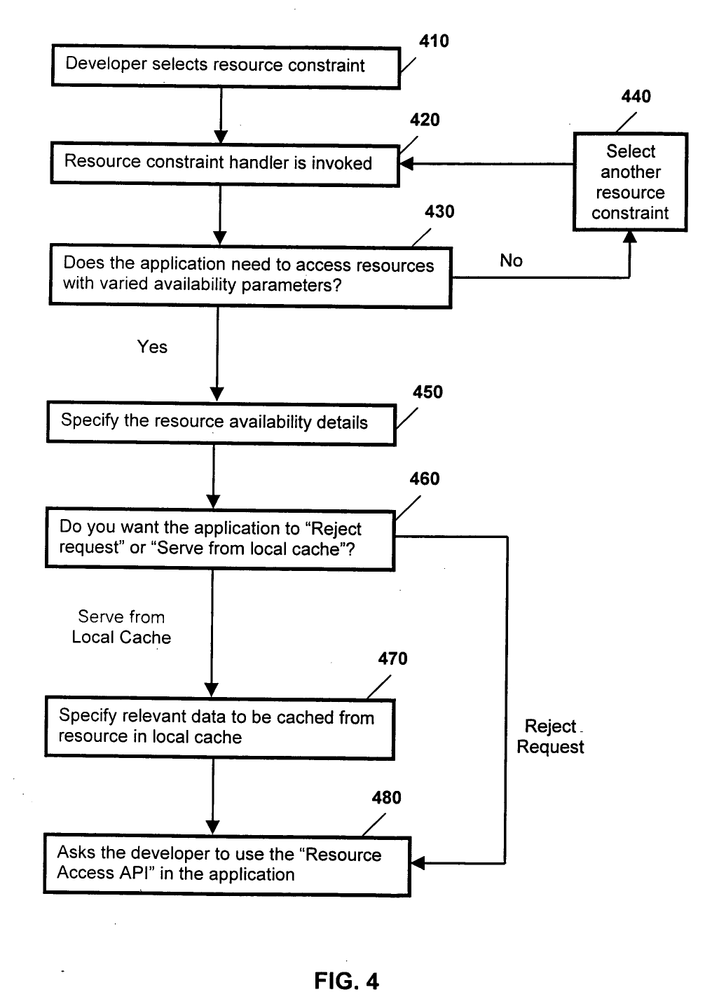

FIG. 4 is a flow chart of steps involved in processing constraints having varied availability parameters. The developer selects the resource Constraint 230 in step 410, and the corresponding Constraint Handler 220 in step 420. A determination is made in step 430 whether or nor the application needs to access resources having varied availability parameters. If not, then another resource Constraint 230 is selected, and a similar determination of step 420 is repeated for the new Constraint 230.

For Constraints 230 that do have varied availability resources, the resource availability details are specified in step 450. A determination is made in step 460 of whether the application is to reject the request, or serve the requested from the local cache. If the requested is served from a local cache, then the relevant data is specified that is to be retrieved from the local cache in step 470. The developer is then prompted to use the “Resource Access API” in the application in step 480. If the request is to be rejected, then the developer is instead immediately prompted as per step 480.

The tool T allows the developer to specify the data source availability parameters. The tool suggests the developer use a specific library for data source connectivity. The tool T also asks the developer if the appli0cation is to reject a client request when the data source is not available, or copy the relevant data from the data source in a local cache and serves client requests from the local data. There is a way to specify the relevant data of a data source as well.

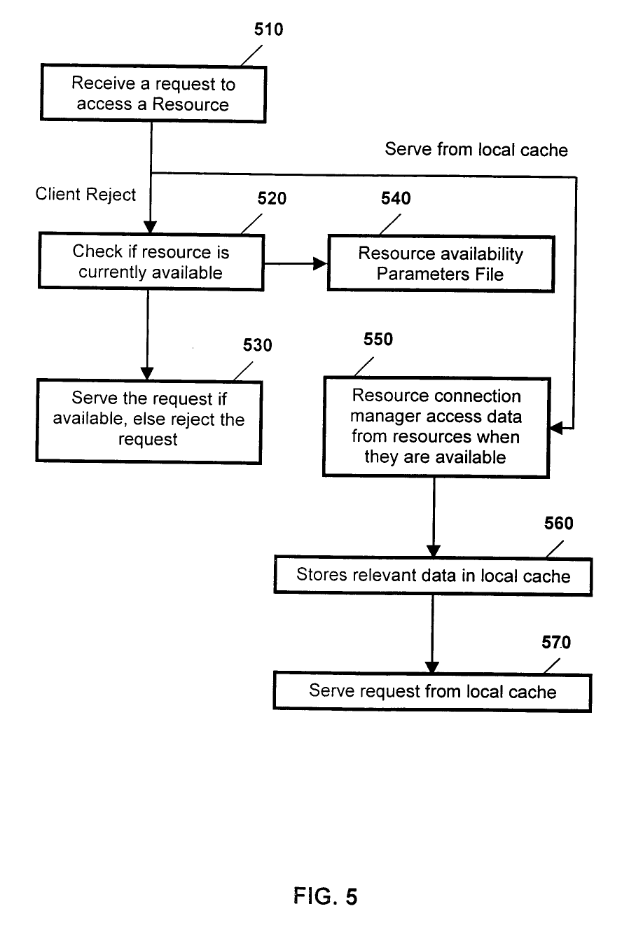

FIG. 5 is a flow chart of steps performed by the tool T in interacting with the developer. There is a policy file which stores the availability parameters of various resources specified by the developer. A request to access a resource is received in step 510. In the “client request reject” scenario, the “connect” method in the library checks the policy file to see if the data source is currently available (step 520) to process the request in step 540, else the method rejects the request in step 530. For the “serve from local cache” scenario, a data source connection manager accesses the resources when available in step 550 and caches the relevant data in a local copy (step 560) for use when the data source is not available (step 570).

The data source connection manager reads the policy file and determines the time when should connect with various resources. Various mechanisms can be used to trigger the appropriate time to connect, such as an event manager or database triggers or an alarm system. On receiving a client request, the “connect” method either accesses the data source directly if available, else, the method processes the request from the local cache of the data source.

Computer Hardware

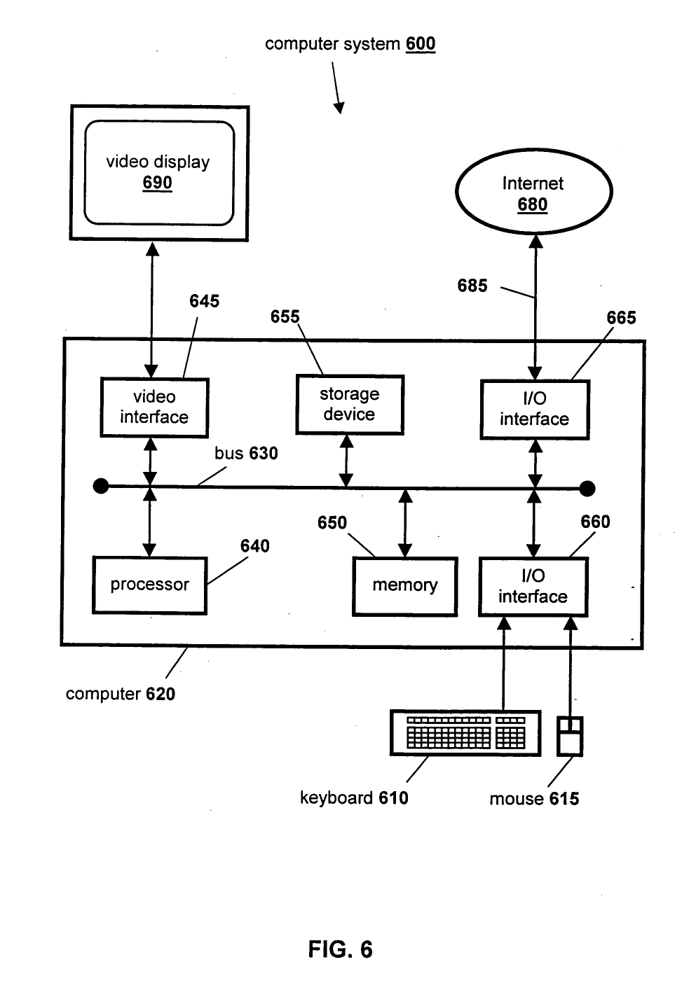

FIG. 6 is a schematic representation of a computer system 600 of a type that is suitable for executing computer software (described herein as tool T) for developing an application as described herein. Computer software executes under a suitable operating system installed on the computer system 600, and may be thought of as comprising various software code means for achieving particular steps.

The components of the computer system 600 include a computer 620, a keyboard 610 and mouse 615, and a video display 690. The computer 620 includes a processor 640, a memory 650, input/output (I/O) interfaces 660, 665, a video interface 645, and a storage device 655.

The processor 640 is a central processing unit (CPU) that executes the operating system and the computer software executing under the operating system. The memory 650 includes random access memory (RAM) and read-only memory (ROM), and is used under direction of the processor 640.

The video interface 645 is connected to video display 690 and provides video signals for display on the video display 690. User input to operate the computer 620 is provided from the keyboard 610 and mouse 615. The storage device 655 can include a disk drive or any other suitable storage medium.

Each of the components of the computer 620 is connected to an internal bus 630 that includes data address, and control buses, to allow components of the computer 620 to communicate with each other via the bus 630.

The computer system 600 can be connected to one or more other similar computers via a input/output (I/O) interface 665 using a communication channel 685 to a network, represented as the Internet 680.

The computer software may be recorded on a portable storage medium, in which case, the computer software program is accessed by the computer system 600 from the storage device 655. Alternatively, the computer software can be accessed directly from the Internet 680 by the computer 620. In either case, a user can interact with the computer system 600 using the keyboard 610 and mouse 615 to operate the programmed computer software executing on the computer 620.

Other configurations or types of computer systems can be equally well used to execute computer software that assists in implementing the techniques described herein.

### CONCLUSION

Various alterations and modifications can be made to the techniques and arrangements described herein, as would be apparent to one skilled in the relevant art.

1. A method for developing a computer application, said method comprising:
determining constraints associated with infrastructure upon which the application is to be deployed;
recording parameters associated with the determined constraints; and
resolving any conflicts between determined constraints having incompatible parameters; and
modifying at least one component of the application based upon the recorded parameters of the determined constraints.

2. The method of claim 1, further comprising presenting possible options for the constraints.

3. The method of claim 2, further comprising selecting parameters associated with determined constraints.

4. The method of claim 1, further comprising identifying whether the determined constraints have parameters that are static or dynamic.

5. The method of claim 4, further comprising categorizing the determined constraints in distinct categories.

6. The method of claim 5, further comprising identifying parameters that are dynamically related to determined constraints that are differently categorized.

7. The method of claim 1, further comprising incorporating into the application respective Application Programming Interfaces (API) for at least one of the determined constraints.

8. A computer program comprising computer software recorded on a computer-readable medium for performing a method for developing a computer application, said method comprising:
determining constraints associated with infrastructure upon which the application is to be deployed;
recording parameters associated with the identified constraints; and
resolving any conflicts between identified constraints having incompatible parameters; and
modifying at least one component of the application based upon the recorded parameters of the identified constraints.

9. A computer system for developing a computer application, said computer system comprising:
means for determining constraints associated with infrastructure upon which the application is to be deployed;
means for recording parameters associated with the determined constraints; and
means for resolving any conflicts between determined constraints having incompatible parameters; and
means for modifying at least one component of the application based upon the recorded parameters of the determined constraints.

10. The computer program of claim 8, wherein said method further comprising presenting possible options for the constraints.

11. The computer program of claim 10, wherein said method further comprising selecting parameters associated with determined constraints.

12. The computer program of claim 8, wherein said method further comprising identifying whether the determined constraints have parameters that are static or dynamic.

13. The computer program of claim 12, wherein said method further comprising categorizing the determined constraints in distinct categories.

14. The computer program of claim 13, wherein said method further comprising identifying parameters that are dynamically related to determined constraints that are differently categorized.

15. The computer program of claim 8, wherein said method further comprising incorporating into the application respective Application Programming Interfaces (API) for at least one of the determined constraints.

16. The computer system of claim 9, further comprising:
means for presenting possible options for the constraints; and
means for selecting parameters associated with determined constraints.

17. The computer system of claim 9, further comprising means for identifying whether the determined constraints have parameters that are static or dynamic.

18. The computer system of claim 17, further comprising means for categorizing the determined constraints in distinct categories.

19. The computer system of claim 18, further comprising means for identifying parameters that are dynamically related to determined constraints that are differently categorized.

20. The computer system of claim 9, further comprising means for incorporating into the application respective Application Programming Interfaces (API) for at least one of the determined constraints.
